(19) United States
(12) Patent Application Publication
(10) Pub. No.: US 2018/0010902 A1
(43) Pub. Date: Jan. 11, 2018

(54) FABRIC WITH STRETCHABLE SENSORS FOR SHAPE MEASUREMENT

(71) Applicant: Figur8, Inc., Boston, MA (US)

(72) Inventor: Nan-Wei Gong, Cambridge, MA (US)

(21) Appl. No.: 15/681,420

(22) Filed: Aug. 20, 2017

Related U.S. Application Data
(63) Continuation-in-part of application No. 15/271,863, filed on Sep. 21, 2016.
(60) Provisional application No. 62/377,644, filed on Aug. 21, 2016.
(60) Provisional application No. 62/464,443, filed on Feb. 28, 2017.
(60) Provisional application No. 62/221,590, filed on Sep. 21, 2015.

(51) Int. Cl. G01B 7/16; A41H 1/02

(52) U.S. Cl. CPC G01B 7/16; A41H 1/02

(57) ABSTRACT

Disclosed embodiments provide a way to perform body measurements. A garment has a sensor module attached. The garment encompasses a body portion. The sensor module is stretchable and provides electrical data. The electrical data is based on an amount that the sensor module is stretched. The electrical data from the sensor module is collected. The collected electrical data is analyzed to determine a measurement for the body portion. A size for the body portion is calculated, based on the measurement. A second sensor module is attached to the garment. Electrical data from the second sensor is also collected and analyzed. A size for the body portion is further calculated based on the electrical data from the sensor module and the second sensor module. The sensor module and the second sensor module transmit data to a computing device using distinct, wireless transmitters.

### RELATED APPLICATIONS

This application claims the benefit of U.S. provisional patent applications “Fabric with Stretchable Sensors for Shape Measurement” Ser. No. 62/377,644, filed Aug. 21, 2016, and “Body Part Deformation Analysis using Wearable Body Sensors” Ser. No. 62/464,443, filed Feb. 28, 2017.

This application is also a continuation-in-part of U.S. patent application “Electronic Fabric for Shape Measurement” Ser. No. 15/271,863, filed Sep. 21, 2016, which claims the benefit of U.S. provisional patent application “Electronic Fabric for Shape Measurement” Ser. No. 62/221,590, filed Sep. 21, 2015.

Each of the foregoing applications is hereby incorporated by reference in its entirety.

### FIELD OF ART

This application relates generally to size measurement and more particularly to fabric with stretchable sensors for shape measurement.

### BACKGROUND

The accurate measurement of a given three-dimensional shape has many applications in the fields of garments, clothing, protection, industrial automation, scientific research, and recycling/reclamation, among others. The measured shapes can be objects of interest, manufactured parts, etc. The shape measurement can be used for object differentiation. In shape measurement applications that involve the human body, there are further applications in the healthcare and fashion industries. While the former is used to obtain data necessary to obtain medical information and to design medical treatments, the latter is used to determine the proper fit of clothing, accessories, and equipment. The proper fit of clothing and equipment is essential for comfort, safety, and appearance, particularly for people who are in physically strenuous professions such as emergency response, law enforcement, defense, athletics, and the like. Footwear in particular is an item of clothing in which sizing is of utmost importance in order to reduce or eliminate the risks of fatigue, injury, and so on.

Since a person's clothing and shoe sizes can change over time, body measurements may need to be periodically reassessed so that clothing and footwear can be properly updated to accommodate for size changes in order to promote comfort and functionality. As people grow and age, their physical size changes. The period of most rapid change, of course, occurs in children, where their growth rate may be classified into two distinct stages: before puberty and during puberty. In the first stage, a prepubescent child tends to grow at a steady rate of about two to three inches per year between the approximate ages of two and ten until the start of puberty, when a rapid growth spurt signals the development of a child into their full adult size. This second pubescent stage generally occurs between the ages of nine and fifteen. Even after a child has developed into an adult, muscle mass, weight, and physical shape continue to change throughout adulthood for reasons such as pregnancy, diet, weight gain or loss, strength training, injury, illness, and so on. In addition, people may have daily fluctuations in size due to diet, water retention, stress, altitude, and other factors.

Properly sized clothing and footwear is important for appearance, safety, and comfort. For specialized occupations such as firefighting, athletics, and construction work, properly fitting clothing and footwear is essential in order to successfully perform the needed tasks. As people's physical measurements change with age, shoe and clothing size is often reevaluated to ensure a proper fit and thus provide functionality and comfort in a variety of settings.

### SUMMARY

Properly sized garments of all descriptions, such as clothing and footwear, as well as equipment worn on the body, are critical to personal comfort, safety, and appearance. While a loose-fitting jacket may be considered fashionable, an ill-fitting respirator or mask can be life threatening. The sizes and shapes of bodies tend to change over time as people grow and age. It is therefore desirable to take body measurements from time to time to ensure that clothing, footwear, and equipment continue to fit properly. Disclosed embodiments provide a fabric garment for measurement. The garment, which includes a fabric and a stretchable electronic sensor module, can be formed into articles of clothing, such as socks, pants, shirts, hats, and gloves. The sensor module has a property of changing electrical properties, such as resistance and/or capacitance, when stretched. By calculating the change in electrical properties when a wearer is wearing such a garment, physical dimensions can be ascertained. The physical dimensions can include size, shape, circumference, diameter, volume, surface area, etc., and can then be converted to a higher level size such as a shoe size, blouse size, or the like.

Disclosed embodiments provide shape measurements and body measurements. A garment has a sensor module attached. The garment encompasses a body portion. The sensor module is stretchable and provides electrical data. The electrical data is based on the amount that the sensor module is stretched. The electrical data from the sensor module is collected. The collected electrical data is analyzed to determine a measurement for the body portion. A size for the body portion is calculated, based on the measurement. A second sensor module can also be attached to the garment. Electrical data from the second sensor is also collected and analyzed. A size for the body portion is further calculated based on the electrical data from the sensor module and the second sensor module. The sensor module and the second sensor module transmit data to a computing device using distinct, wireless transmitters. A processor-implemented method for body measurement is disclosed comprising: attaching a sensor module to a garment, wherein the sensor module is stretchable and provides electrical data based on an amount that the sensor module is stretched, and wherein the garment encompasses a body portion; collecting the electrical data from the sensor module based on the amount that the sensor module stretched; analyzing the electrical data that was collected to determine a measurement for the amount that the sensor module stretched; and calculating a size for the body portion based on the measurement that was determined.

In embodiments, also disclosed is attaching a second sensor module to the garment; collecting a second electrical data from the second sensor module, wherein the second electrical data is collected based on stretching of the second sensor module; analyzing the second electrical data that was collected to determine a second measurement for the amount that the second sensor module stretched; and further calculating the size for the body portion based on the measurement and the second measurement that were determined. In embodiments, disclosed is a computer program product embodied in a non-transitory computer readable medium for body measurement, the computer program product comprising code which causes one or more processors to perform operations of: attaching a sensor module to a garment, wherein the sensor module is stretchable and provides electrical data based on an amount that the sensor module is stretched, and wherein the garment encompasses a body portion; collecting the electrical data from the sensor module based on the amount that the sensor module stretched; analyzing the electrical data that was collected to determine a measurement for the amount that the sensor module stretched; and calculating a size for the body portion based on the measurement that was determined.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 shows an upper body garment with sensor modules.

FIG. 2 is a flow diagram for shape measurement.

FIG. 3 illustrates an upper body garment with alternative sensors.

FIG. 4 shows an upper body garment with finger gloves.

FIG. 5 illustrates an upper body garment with sensor modules.

FIG. 6 shows a lower body garment with sensor modules.

FIG. 7A illustrates a front view of a dress garment with sensor modules and FIG. 7B illustrates a back view of a dress garment with sensor modules.

FIG. 8 illustrates an infant/toddler garment.

FIG. 9 shows an upper body garment with interconnects and pickup points.

FIG. 10 illustrates electrodes and a dielectric.

FIG. 11 shows resistive and piezoelectric sensors.

FIG. 12 illustrates a processing module for sensing.

FIG. 13 is a diagrammatic representation of material for measuring a lower leg.

FIG. 14 illustrates a garment for detecting foot sizing.

FIG. 15 is a system for garments with stretchable sensor modules for shape measurement.

### DETAILED DESCRIPTION

Disclosed embodiments provide a way to measure the shape and size of an object using a sensor module attached to a garment, particularly the measurement of human body portions such as legs, arms, head, feet, and the like. The measurements can be acquired by simply wearing a garment comprised of one or more sensor modules. Changes in electrical properties such as resistance and/or capacitance and/or inductance are measured. These electrical properties are converted to distance measurements. The measurements are collected by a processor. The processor can analyze the data to determine sizing information, or the measurement data can be transmitted elsewhere to a server or other device so that the sizing information can be converted to a higher level size, such as a dress size or other common system of apparel measurement. Alternatively, the sizing information can be converted to a clothing pattern to efficiently enable fabrication of customized clothing based on size.

Another application of the disclosed embodiments is the measuring of size over time. The sizing information can be acquired from a local processor and can then be uploaded via a near field communication system, such as Bluetooth™ to a mobile phone, for data collection and analysis. Such size and shape data collection can have applications in the field of physical health and wellness, as the monitoring of size over time can provide useful medical information. For example, an undergarment equipped with a measuring garment integrated into the waistband can provide daily updates on waist size. The garment can then transmit results to a user's mobile phone. The mobile phone can execute a program (app) to track waist size and alert the user if the waist size exceeds a predetermined level, which can, in turn, alert the user to cut back on caloric intake. Another application of periodic measurement can pertain to athletes. In such an embodiment, bodybuilders, weight lifters, runners, or other athletes can easily track size increases and decreases as they train.

In other embodiments, the quick assessment of size in an electronic form allows for unprecedented capabilities in custom-manufactured clothing, safety devices, personal equipment such as earphones, etc. For example, a user can use a measuring garment to quickly obtain detailed foot measurements and transmit the measurements to an online shoe store. Customized shoes can be manufactured to the specifications of the measurements provided by the user. Alternatively, the shoe store can search a product database to select existing footwear that most closely matches the detailed size information provided by the measuring garment. These, among others, are just a few applications for the use of measuring clothing and footwear size using a sensor module attached to a garment. In numerous cases, sizes are critical to correct fitting of garments or devices used for protection or safety. In such uses, precise sizing is essential such as in the case of astronauts, scuba divers, soldiers, airmen, pilots, marines, and so on. People who wear uniforms or safety devices can benefit from proper and easy sizing evaluation. Further, correct sizing can be quite helpful for people such as pregnant mothers, plus size people, big and tall individuals, others who are larger than average or smaller than average, people whose size changes rapidly, and the like. In addition, business attire, athletic apparel, and other garments can be optimally fit for best usage and appearance.

The measurements that can be obtained from the garment can be based on a circumference of a portion of a body. Such a measurement can include the circumference of an arm or a leg, and can be used to determine a size of the limb, a change in size (size delta) of the limb, and so on. The size delta for the limb can be used as in a medical application to track edema. The measurements can include a size such as a length, a width, a thickness, and so on. The measurements can include a distance between landmarks of a body or portion of a body, such as the distance between a shoulder and an elbow, and elbow and a wrist, a hip and a knee, a knee and an ankle, etc. The measurements for sizing can be used for preoperative evaluations, postoperative tracking, sizing of medical appliances, etc.

Other measurements can also be obtained from the garment. The other measurements can include measuring linear displacement or elongation of a portion of a body. The elongation that can be measured and/or inferred can be based on a changing angle of the portion of the body. The portion of the body can include an elbow, a knee, an ankle, a neck, a shoulder, a hip, etc. The measuring of an angle can be used for such applications as postoperative physical therapy to determine progress relating to range of motion of the portion of the body. The measuring of the size and the angle relating to range of motion of the portion of the body can be used to evaluate progress toward postoperative physical therapy goals, to identify excess swelling, to fit a medical device such as a brace or cast, and so on.

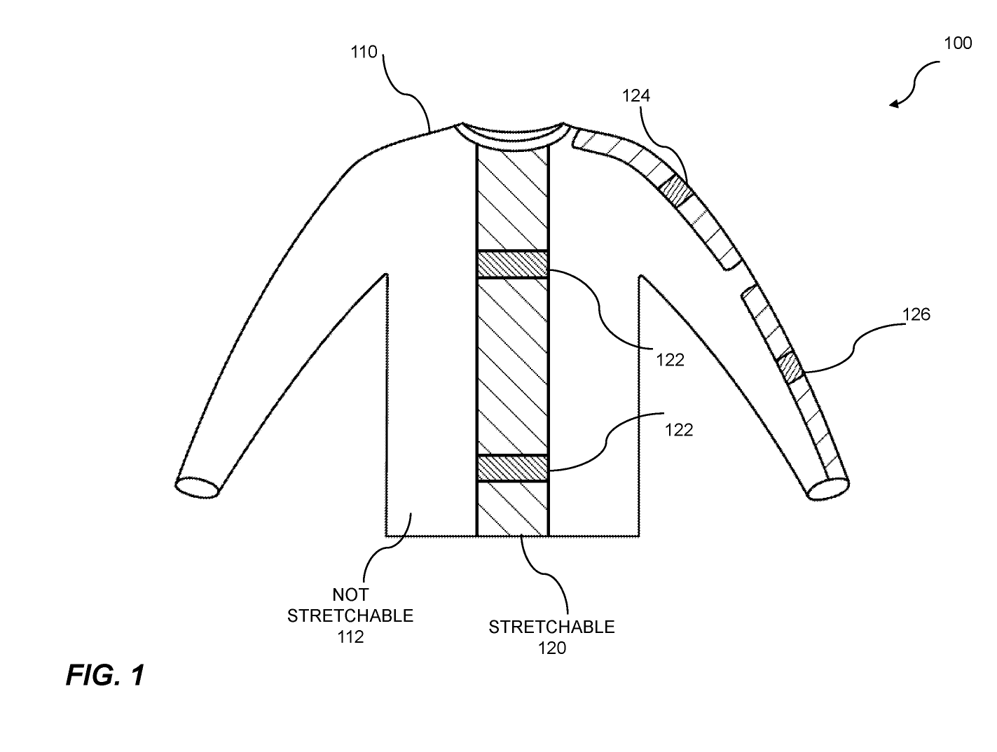

FIG. 1 shows an upper body garment with sensor modules. Fabric with stretchable sensors can be used for shape measurement. A garment can have a stretchable sensor module attached. The measuring garment can encompass a body portion. The measuring garment can be placed on a body portion, worn on a body portion, and so on. The garment can include a sensor module that is stretchable. The sensor module can include a sensor that can measure an amount of stretch when attached to a garment. The sensor module can provide electrical data based on an amount that the sensor module is stretched. The amount of stretch that is measured can be used for shape measurement. The electrical data from the sensor module can be collected by the sensor module itself. Alternatively, the data can be collected by an external computing device. The electrical data that is collected can be analyzed to determine a measurement for the amount of stretch of the sensor module. The analyzing can be performed by the sensor module or by an external computing device. A size is calculated for the body portion based on the measurement that was determined. The calculation can be performed by the sensor module or by an external computing device.

The FIG. 100 describes a fabric with stretchable sensors for shape measurement. The fabric of garment 110 can encompass a body portion, where the body portion can be a limb, a torso, a head, a hand, a foot, and so on. In embodiments, the body portion can include a foot, an ankle, a calf, a knee, a thigh, thighs, a torso, a waist, hips, a chest, a bust, an under-bust, a side-to-bust, a back, a neck, shoulders, a forearm, a hand, a finger, an upper arm, a lower arm, a neck, a head, an arm length, a leg length, a torso length, or a body length. In embodiments, the garment can include a dress, a skirt, pants, slacks, shorts, an undergarment, a bra, a baby blanket, a baby towel, a baby bunting, a hat, a scarf, a glove, a sock, a shoe, a boot, a shirt, a blouse, a wrap, a cover-up, a bathing suit, a bathrobe, a suit jacket, a vest, a shawl, a fashion accessory, a veil, or a headband. In embodiments, all of the fabric encompassing the body portion can be stretchable. The garment encompassing the body portion can be used to obtain such information as body portion size and shape. In other embodiments, all of the fabric encompassing the body portion can be stretchable in a single direction. The latter fabric encompassing a body portion can be used to obtain information such as length, circumference, etc. A sensor module that is stretchable can be part of the garment, and the sensor module can include a sensor for measuring the amount of stretch of the module. Thus, when the part of the fabric of the garment that is the electronic component is stretched, the amount of stretch can be measured. The values captured by the sensor can be analyzed to determine a size, shape, or other physical parameter relating to the body portion encompassed by the garment. The values that are captured from the sensors can be measurement values, or can be converted to measurement values by translation, table lookup, calculation, and so on.

The garment 110 can be placed on a body portion, worn on a body portion, and so on. Various fasteners can be used to hold the garment in an appropriate position as the garment encompasses the body portion. In embodiments, the sensor module can be integrated with a closing device. The closing device can be a zipper, a snap, a button, a cufflink, a tie, a strap, a clasp, a self-fastening hook and loop material, or an elastic. In embodiments, a coupling zipper can be attached to the fabric encompassing the body portion. Other fastening techniques can include snaps, hook and loop fasteners, tie strings, straps, etc. Upon closing, the coupling zipper can actuate the electronic component to perform the measurement, calculating the amount of stretch as the coupling zipper secures the fabric encompassing the body portion to the body portion. Other actuation techniques can include push buttons, contact switches, thermal switches, etc. In another embodiment, a coupling button can be attached to the fabric encompassing the body portion. As was the case for the zipper fastener, the coupling button can actuate the electronic component to perform the measurement, calculating the amount of stretch as the coupling button secures the fabric encompassing the body portion to the body portion. Similar actuation techniques can be applied to the other fastening techniques such as those mentioned above. In a further embodiment, a finger loop can be attached to the fabric encompassing the body portion. The finger loop can be used to secure the end of part of the garment such as a sleeve. A tug on the finger loop can actuate the electronic component to perform the measurement, calculating the amount of stretch encompassing the body portion to the body portion.

In embodiments, a coupling zipper can be attached to the garment encompassing the body portion. The coupling zipper can actuate the sensor module to collect the electrical data as the coupling zipper secures the garment encompassing the body portion. In embodiments, a coupling button can be attached to the garment encompassing the body portion. The coupling button can actuate the sensor module to collect the electrical data as the coupling button secures the garment encompassing the body portion. The coupling button can comprise a button, a snap, a cufflink, a clasp, or a tie. In embodiments, a finger loop can be attached to the garment encompassing the body portion. A tug on the finger loop can actuate the sensor module to collect the electrical data on the garment encompassing the body portion.

The garment 110 can include non-stretchable fabric 112 and stretchable fabric 120. The stretchable fabric 120 can include one or more sensor modules 122 as shown. Other sensor modules can be included in other portions of stretchable fabric such as sensor modules 124 and 126. The various sensor modules can be used to determine size and/or shape information regarding various body portions. For example, sensor modules 122 can be used to determine chest size and waist size, while sensor module 124 can be used to determine upper arm length and size, and sensor module 126 can be used to determine lower arm length and size. The sensors modules, which include electronic components that can be parts of the garment, can be coupled to the garments using various techniques. The sensors can be printed on the garment, applied to the garment, and can be part of the fabric of the garment. The fabric can include a textile. In embodiments, the fabric is woven and the electronic component can be woven into the garment. In another embodiment, the fabric can be knitted and the electronic component can be knitted into the garment. In a further embodiment, the fabric can include a Jacquard weave. The Jacquard weave can include an intricate pattern in the garment where the weave and/or intricate pattern can include one or more electronic components, sensors, and so on. Other configurations of the garment can be imagined. As mentioned, the garment can include stretchable fabric and non-stretchable fabric. A non-stretchable fabric can be part of the garment and the non-stretchable fabric can be coupled to the electronic component that is stretchable. In another configuration, the electronic component that is stretchable can be part of a band of fabric within the fabric encompassing the body portion. Part or all of the band of fabric can be stretchable. The band can be used to measure length, a width, a spacing, and so on. Other measurements of the body portion can be determined. The electronic component can include one or more sensors can measure a circumference of the body portion. The remainder of the band of fabric can include the non-stretchable fabric.

The garment with stretchable sensor modules for shape measurement includes a collecting and analyzing module for collecting electrical data from the stretchable sensor and analyzing the collected electrical data to determine a measurement based on the amount of stretch. Each sensor module 122, 124, or 126 can include at least one sensor, one or more electrical devices communicatively coupled to the at least one sensor, a battery coupled to the one or more electrical devices, and a communication device. The sensor module can also include pickups for measuring an electrical property such as resistance, capacitance, inductance, reluctance, etc., and a signal generator for generating direct current and/or alternating current active signals to facilitate the measurements.

The sensor module can provide active signals to the electronic component to determine capacitance values. The active signals can include different frequencies, periods, waveforms, phases, duty cycles, etc. The active signals can sweep through a range of frequencies in order to determine the capacitance values. Thus, in some embodiments, a frequency sweep is used to cover a range of frequencies. The sensor module can comprise a stretchable capacitive material. The stretchable capacitive material can have a capacitance that increases as a stretch amount increases. In embodiments, the sensor module can comprise a stretchable resistive material. The stretchable resistive material can have a resistance that increases as a stretch amount increases. In embodiments, the sensor module comprises a polymer. In embodiments, the collecting the electrical data is enabled by active signals generated within the sensor module. In embodiments, the active signals enable the sensor module to determine capacitance values. In embodiments, the active signals sweep through a range of frequencies in order to determine the capacitance values.

Additionally, the sensor module can include an interface port, such as a micro-USB port, a wireless communication capability such as a Bluetooth™ interface, and/or one or more buttons. The sensor module can comprise a memory for storing data based on the electrical data that was collected from the one or more sensor modules. The processing element can gather the measurement information to calculate higher level sizing information. The higher level sizing information can include a garment size. The higher level sizing information can include blouse and shirt sizes, skirt and pants sizes, dress sizes, suit sizes, shoe sizes, etc. In embodiments, the measurement data is transmitted to a computing device that is distinct from the sensor module. Thus the analyzing can produce electrical information. The analyzing can be performed on the sensor module. The electrical information can be transmitted to a computing device. The transmitting can be accomplished over a wireless network. The wireless network can include Bluetooth™ transmission. In embodiments, the communication device includes wireless communication capability. In embodiments, the sensor module gathers dimension information on the size that was calculated. The dimension information can include a length, a width, a spacing, or a circumference. The dimension information can be used to generate the appropriate system of apparel sizing information for the garment or equipment. In embodiments, the sensor module measures a circumference of the body portion or a length of the body portion.

The garment 110 can comprise non-stretchable fabric. The garment that comprises non-stretchable fabric can lack non-stretchable fabric where the sensor module resides. In embodiments, the garment that comprises non-stretchable fabric has no fabric where the sensor module resides. In embodiments, the garment that comprises non-stretchable fabric can further comprise stretchable fabric where the sensor module resides. The garment 110 can comprise fabric that is substantially stretchable in only one direction, which can be called the primary stretchable direction. When a direction of stretch in a fabric is less than 10% stretchable when compared to the primary stretchable direction, it can be considered substantially stretchable in only one direction, given that the direction of stretch is at least at a 20° angle from the primary direction. In embodiments, the entire garment encompassing the body portion can be stretchable. In embodiments, the sensor module can be integrated within the garment that encompasses the body portion. In embodiments, the amount that the sensor module is stretched can measure a torso diameter, a torso length, a neck diameter, an arm diameter, an arm length, a leg diameter, a leg length, a foot diameter, or a foot length.

The processing element of the sensor module can employ power management. Power management can be used for placing the sensor module into a low power mode, waking up the processing module, charging any batteries in processing module, inductively providing power to the processing module, etc. The processing element can be detachable from the fabric. In some embodiments, the sensor module is removable from the garment 110 at its attachment points. The sensor module that is removed can then be reused on another garment or with different attachment points on the same garment. In some embodiments, the one or more electrical devices employ power management. In some embodiments, the information used to determine sizing can be collected during a lower power mode, and the information used to determine sizing can be transmitted during a higher power mode.

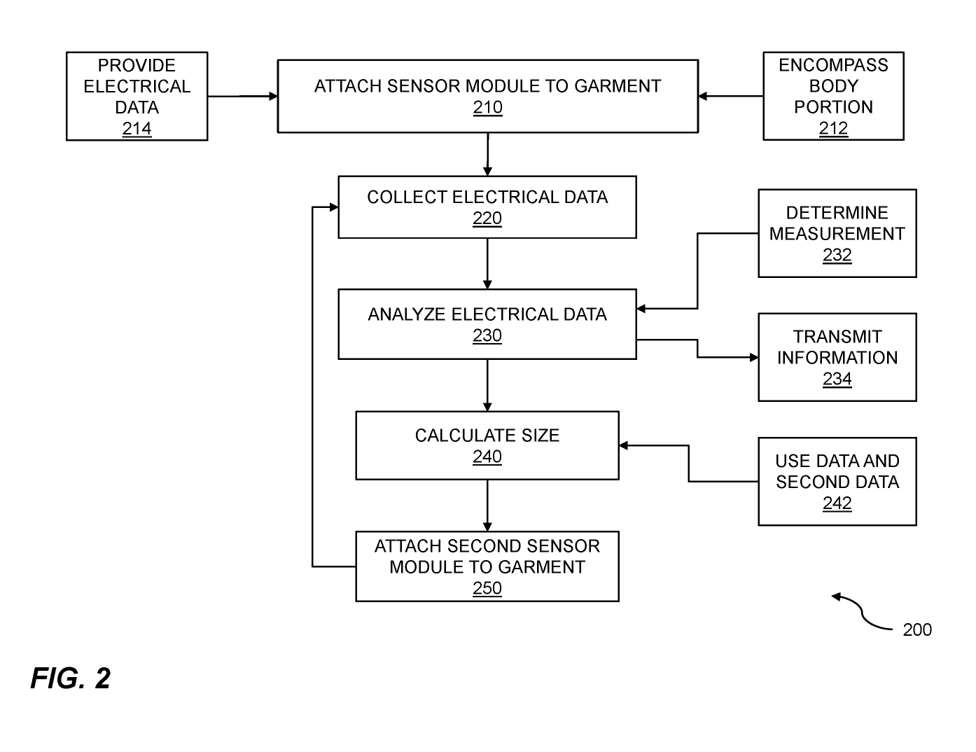

FIG. 2 is a flow diagram for shape measurement. A fabric garment with stretchable sensor modules can be used for shape measurement. A measuring garment can include fabric with stretchable sensor modules. The measuring garment can encompass a body portion 212. The measuring garment can be placed on a body portion, worn on a body portion, and so on. The garment can include a sensor module that is stretchable. The sensor module can include a sensor that can measure an amount of stretch by the sensor module. The amount of stretch that is measured can be used for shape measurement. The sensor module can provide electrical data 214, based on the amount of stretch of the sensor module when attached to a garment encompassing a body portion. The flow 200 includes attaching a sensor module to a garment 210. The sensor module can include a stretchable capacitive material, a stretchable resistive material, and so on. The stretchable capacitive material can have capacitance that increases as the amount of stretch increases. The stretchable resistive material can have resistance that increases as the amount of stretch increases. The garment can encompass a body portion. The flow 200 includes collecting electrical data 220 from the sensor module based on the amount that the sensor module stretched. A value for capacitance can be obtained from the stretchable capacitive material. A value for resistance can be obtained from the stretchable resistive material. The electrical information for a stretch can be used for sizing dimension information, where the sizing dimension information can include a length, a width, a spacing, and so on.

The flow 200 includes analyzing the electrical data 230 that was collected to determine a measurement 232 for the amount that the sensor module stretched. In embodiments, the measurement can be based on resistance values, capacitance values, or a combination of resistance values and capacitance values. The sensor module can be part of a garment encompassing a body portion. The sensor module can include a sensor that measures the amount of stretch by the sensor module. The measurement information can be transmitted 234. The flow 200 includes calculating a size 240 based on the measurement that was determined. In other words, the electrical values measured (capacitance and/or resistance) can first be converted into size units such as millimeters or inches. This conversion can take place through mathematical formulas and/or lookup tables and can be based on empirical values. In some embodiments, the empirical values can be obtained as part of a calibration process. Then the size units can be converted into a higher level, such as sizing information, which can include a garment size. The size can be a hat size, a shirt size, pants size, a sock size, a shoe size, and so on. The analyzing and the calculating can be performed in a processor or other electronic device contained within the sensor module. In embodiments, the analyzing and/or the calculating can be performed by a computing device distinct from the sensor module. In this case, the electrical data is transmitted from the sensor module to the computing device through a direct connection, a wired connection a wireless connection, an optical connection, an RF connection, and so on.

The flow 200 can include attaching a second sensor module to the garment 250. Second electrical data from the second sensor module can be collected 220 and analyzed 230. The electrical data and the second electrical data can be used 242 to calculate the size 240. In embodiments, disclosed is attaching a second sensor module to the garment; collecting a second electrical data from the second sensor module, wherein the second electrical data is collected based on stretching of the second sensor module; analyzing the second electrical data that was collected to determine a second measurement for the amount that the second sensor module stretched; and further calculating the size for the body portion based on the measurement and the second measurement that were determined. The electrical data and the second electrical data can be transmitted to a computing device. The transmitting can be performed by distinct wireless transmitters on each of the sensor modules. Various steps in the flow 200 may be changed in order, repeated, omitted, or the like without departing from the disclosed concepts. Various embodiments of the flow 200 may be included in a computer program product embodied in a non-transitory computer readable medium for measurement, the computer program product comprising code which causes one or more processors to perform operations.

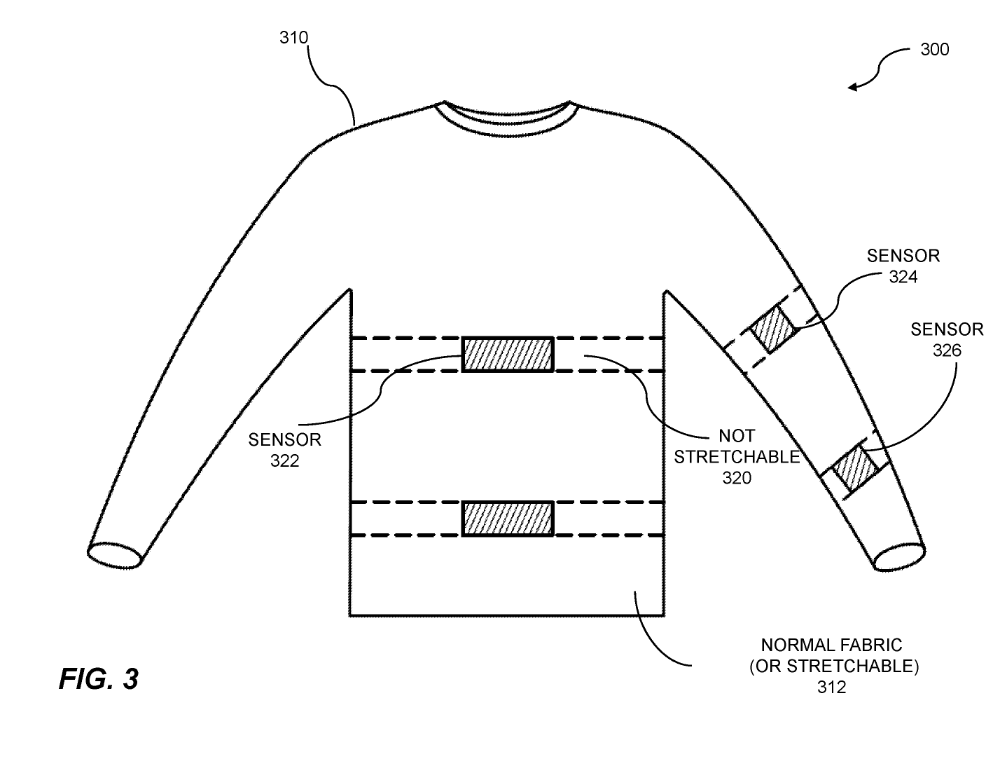

FIG. 3 illustrates an upper body garment with alternative sensors 300. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. A garment 310 is shown than can be used to measure a size and a shape of an upper body portion. The garment 310 can include fabrics with varying characteristics such as normal fabrics or stretchable fabrics 312, non-stretchable fabrics, 320, and so on. The non-stretchable fabric 320 can include a sensor module that is stretchable, where the electronic component includes a sensor for measuring an amount of stretch by the electronic component. Electronic components with sensors 322, 324, and 326 are shown. The electronic components with sensors 322, 324, and 326 can be used for measuring body portions such as sensor 322 for measuring a torso, sensor 324 for measuring an upper arm or biceps and triceps muscles, sensor 326 for measuring a forearm or flexors, extensors, etc. In embodiments, a band composed of a stretchable sensor and non-stretchable material 320 can be used to measure a portion of a body. A series of such bands can be used to measure various portions of a body.

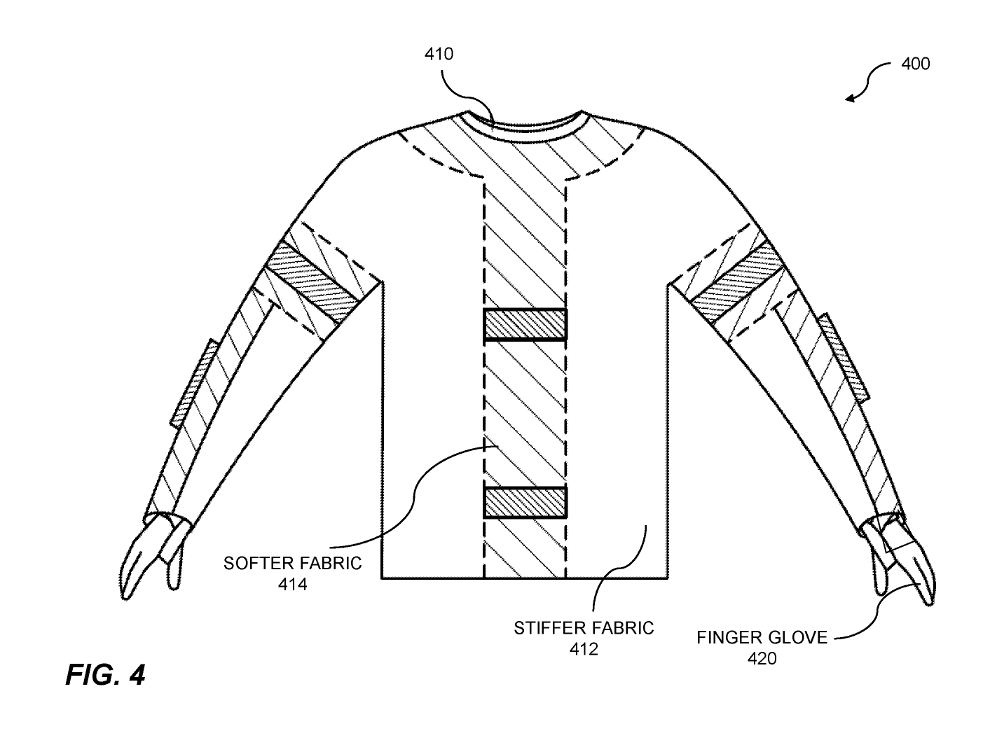

FIG. 4 shows an upper body garment with finger gloves 400. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. A garment 410 is shown than can be used to measure a size and a shape of an upper body portion. The garment 410 can include fabric of various textures such as a stiff fabric 412 and soft fabric 414. The stiffness of the fabric 412 and the softness of the fabric 414 can be relative. The garment 410 can include a finger glove 420. The finger glove can be used to improve anchoring of garment 410 to the arm of a person wearing the garment. The finger glove can improve the accuracy of size and shape measurements, such as an arm length.

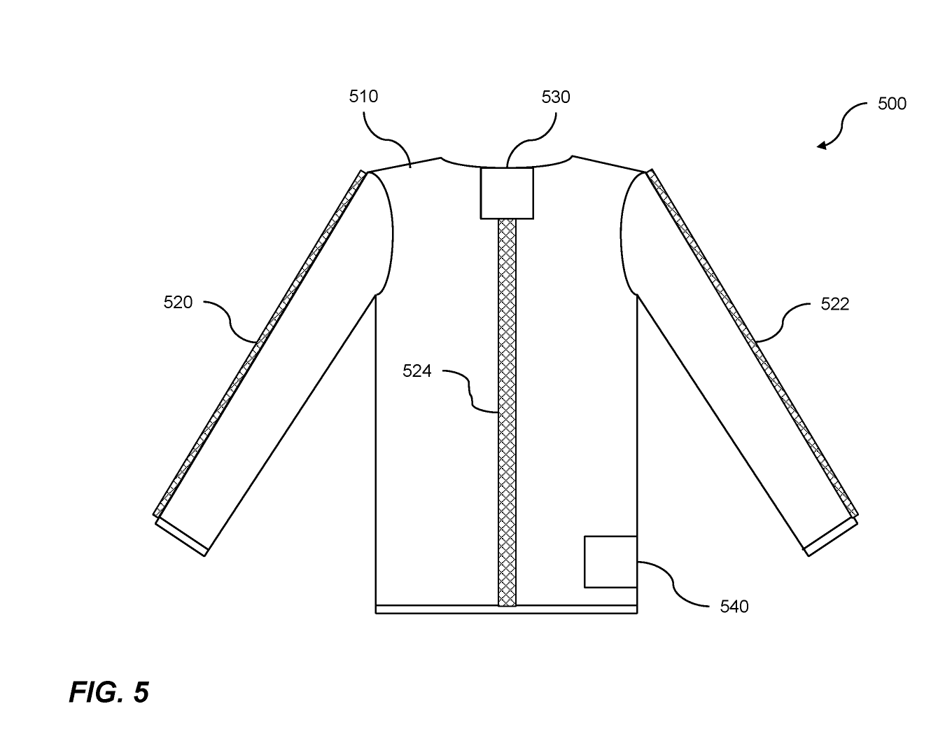

FIG. 5 illustrates an upper body garment with modules 500. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. A garment 510 can include a sensor module that is stretchable such as electronic components 520, 522, and 524. The stretchable electronic components can be used to determine the sizing dimension information of a body portion, where the sizing dimension information can include a length, a width, a spacing, a circumference, etc. The garment 510 can include modules 530 and 540. The modules 530 and 540 can be attached to the garment 510; woven, knitted or otherwise included in the garment; and so on. The modules can serve a variety of purposes such as providing power, communications, signal generation for sensing, displaying data, instructions, and other information, and so on. The modules can include one or more processors. The modules can include flexible batteries and other power sources.

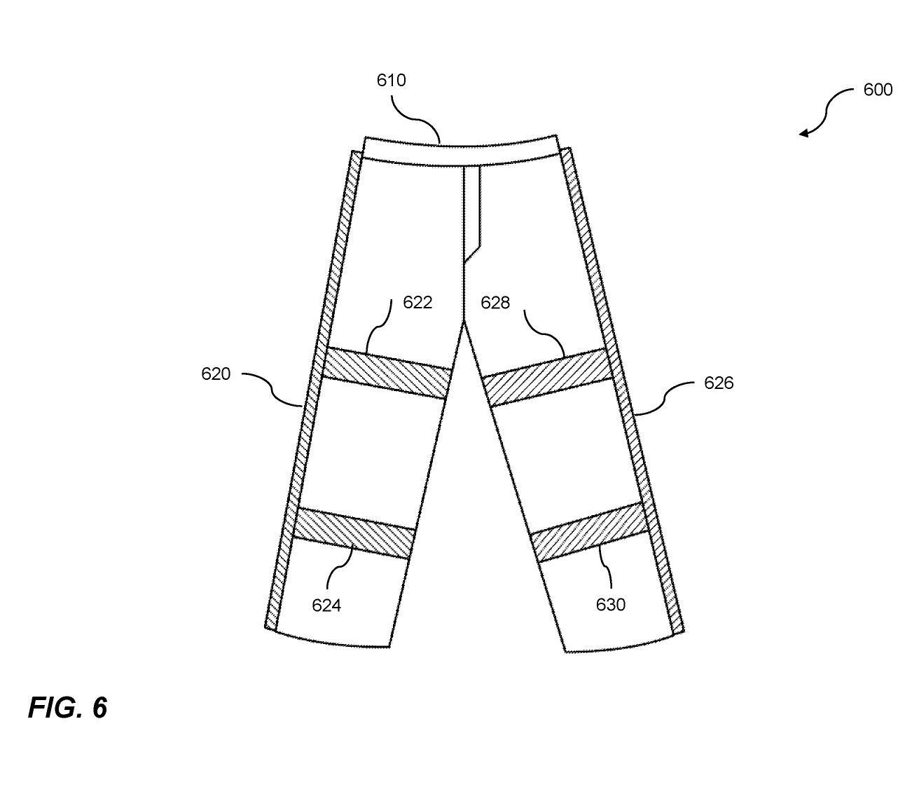

FIG. 6 shows a lower body garment with sensors. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. A lower body garment is shown 600. A lower body garment can include fabric that contains the electronic component. The electric component can include stretchable fabric. A lower body garment can include trousers, shorts, a skirt, tights, or other garment that can be placed on or worn on the lower body. A lower body garment can include various fasteners such as zippers, buttons, toggles, hook and loop tabs, and so on, for placing the garment on a lower body portion. In embodiments, the lower body garment can include leggings. A lower body garment 610 can include a sensor module that is stretchable, where the electronic component includes a senor for measuring an amount of stretch. Lower body garment 610 can include sensors for measuring a length of a lower body portion such as sensors 620 and 626 which can be used for measuring leg length. The lower body garment 610 can include sensors such as sensors 622, 624, 628, and 630 that can be used for measuring circumferences, diameters, radii, etc., of portions of the lower body. While the sensors 622, 624, 628, and 630 are shown to measure left and right thighs and left and right calves, other sensors can be included to measure hips, knees, ankles, feet, etc. Taken together, the sensors can be used to map shapes of lower body portions.

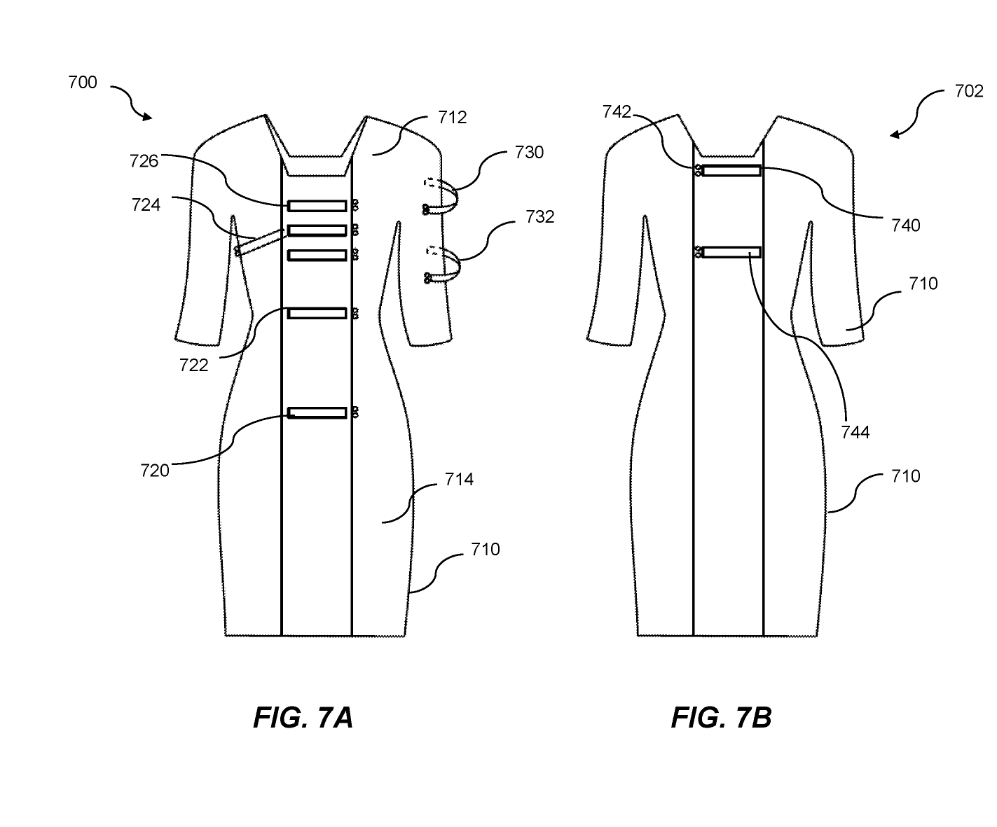

FIGS. 7A and 7B illustrate a front view and a back view, respectively, of a dress garment with sensor modules. It can be challenging to fit a dress or other similar garment to an individual. People vary significantly in shape and size. Individuals themselves can also change in dimension due to weight gain, pregnancy, season, monthly cycle, salt intake, and the like. This dimension change can be useful in evaluating sizes, performing medical evaluations, and other considerations based on size or even minute changes in a person. In embodiments, a sensor module is attached to a garment, wherein the sensor module is stretchable and provides electrical data based on an amount that the sensor module is stretched. The garment can be a dress, a plus-size dress, a petite dress, a skirt, and so on. FIG. 7A 700 illustrates an example front side of a dress 710. The dress can include fabric 714 that encompasses an individual's body. The fabric can be stretchable, stretchable in one dimension, or non-stretchable. The fabric 714 can be uniform or there can be differences in the upper fabric 712 for an upper body portion. Numerous sensors can be attached to the dress 710 in order to measure various portions of a person's body. A sensor 720 can be in the hip region and measure the circumference of the hips based on an amount that sensor 720 stretches. The sensor 720 can have a transmitting module for transmitting the electrical information to a computing device. The transmitting module can use Bluetooth™ or other wireless technology to communicate stretch data, stretch amounts, sizing information, and the like for further evaluation. Each of the sensors that are attached to a garment can have its own transmitting module or there can be a collective transmitting module for multiple sensors. In some embodiments, there can be two, four, or some other number of transmitting modules for a garment such as a dress 710.

Another sensor 722 can be placed in a waist region so that a dimension on the waist of a person can be obtained. One or more sensors 726 can be included to collect a size for the chest region. In some cases additional side sensors 724 can be included to measure the chest or other region of a body. An arm sensor 730 can be included to measure a circumference of an upper arm. A second arm sensor 732 can be included to measure a bicep or other region of the arm.

FIG. 7B 702 illustrates a back view of the dress 710. One or more sensors can be attached to the dress garment 710 on the back portion to further aid in measurement of an individual's size or dimension. A first sensor 740 can be used on an upper back. A second sensor 744 can be used on the lower back. Other sensors can be used to measure the waist, hips, arms, and other portions of the body. Attachment devices, such as buttons 742, can be used to couple the first sensor 742 to the garment. The attachment devices can be on both sides of the sensor so that the sensor can be removed from the garment. The attachment device can be on a single side so that the sensor is only stretched when the attachment device is connected. Various types of attachment devices can be used including a zipper, a snap, a button, a cufflink, a tie, a strap, a clasp, a self-fastening hook and loop material, or an elastic. In some embodiments, the sensor is activated into an “on” state when the attachment device is connected to the sensor. In this situation the coupling button actuates the sensor module to collect the electrical data as the coupling button secures the garment encompassing the body portion where the coupling button can comprise a button, a snap, a cufflink, a clasp, a tie, etc. In some embodiments, a coupling zipper actuates the sensor module to collect the electrical data as the coupling zipper secures the garment encompassing the body portion.

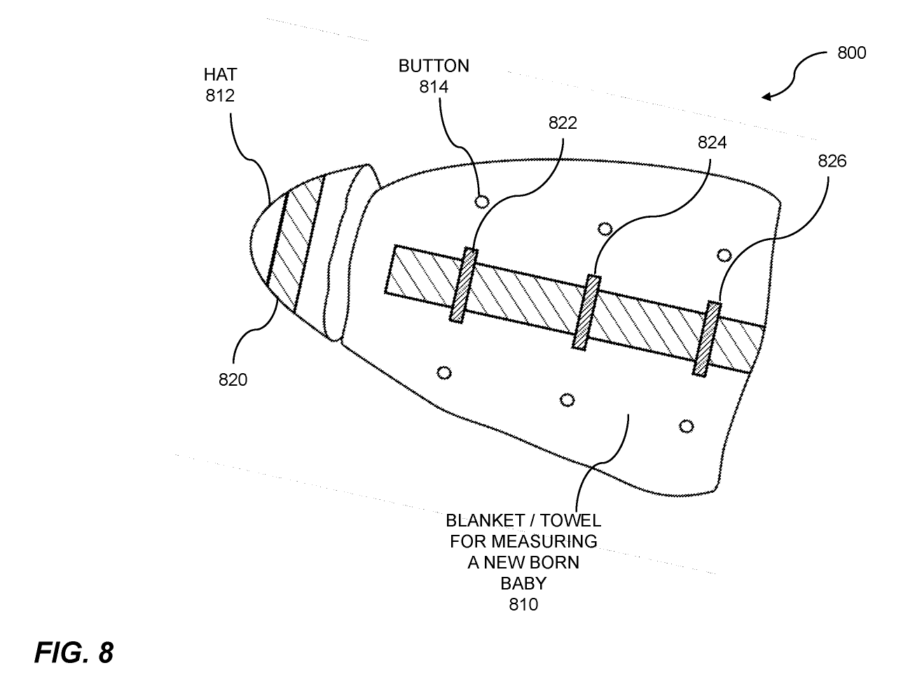

FIG. 8 illustrates an infant/toddler garment. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. A garment, such as a blanket or towel, is shown 800 for measuring body portions of a baby. The baby can be a newborn, an infant, a toddler, and so on. A blanket/towel garment 810 for measuring a newborn baby is shown. The garment 810 can be placed on or wrapped around the baby in order to determine the size and shape of the baby. The garment can include a hat 812 that can be used to measure the size and shape of the baby's head. The garment 810 can be secured to the baby using a button 814, as shown, or a snap, a zipper, a hook and loop closure, and so on. The garment 810 can include one or more electronic components such as electronic components 820, 822, 824, and 826. The electronic components can be stretchable. Sensors can be used to measure an amount of stretch by the electronic component.

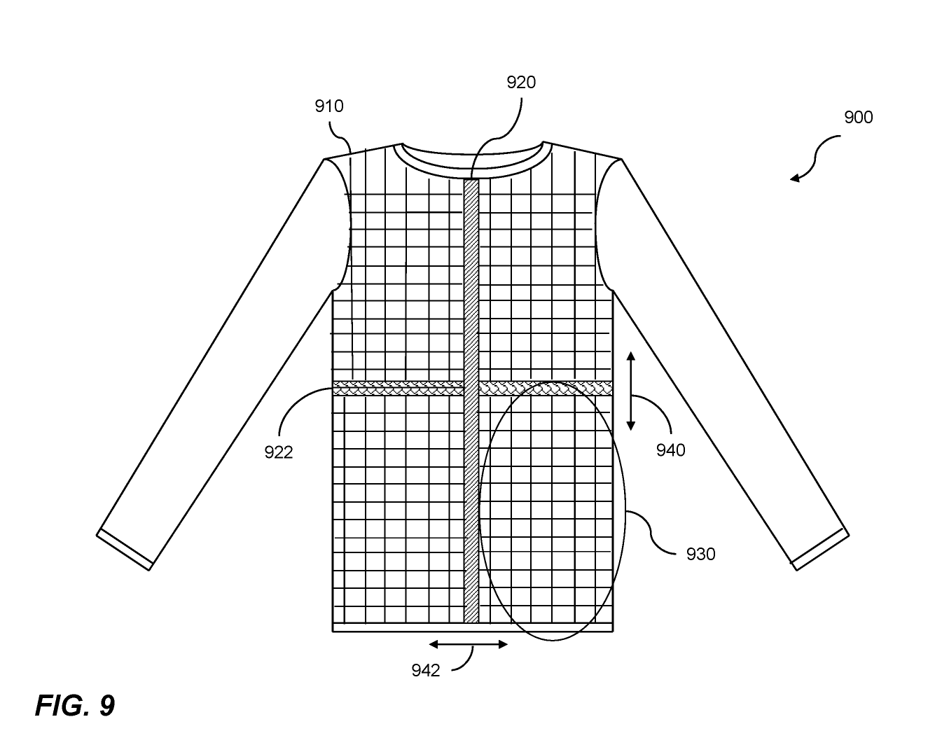

FIG. 9 shows an upper body garment with interconnects and pickup points. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. An upper body garment 910 with interconnects and pickup points is shown 900. While an upper body garment is shown, other garments can be used for size and shape measurement of other body portions. The upper body garment 910 can be placed on a person, worn by a person, and so on. The upper body garment can be secured on the person using various fastening techniques including one or more buttons, one or more zippers, one or more hook and loop fasteners, one or more hooks and eyes, one or more tie strings, and so on.

The garment 910 can include one or more electronic components 920 and 922, where the electronic components are stretchable. The electronic components 920 and 922 can include a sensor that measures and amount of stretch by the electronic component. The electronic components 920 and 922 can act as pickups for size and shape information. The electronic components 920 and 922 are coupled to lines 930 that extend horizontally from electronic component 920 and vertically from electronic component 922. The lines 930 can be conductive. The lines can serve as interconnects for conveying size and shape information. The lines can be resistive, capacitive, inductive, and so on. The lines can be applied to the fabric of the garment 910 where the fabric can be a textile. The fabric can be woven, knitted, a Jacquard weave, and so on. As a person wears garment 910, the lines coupled to electronic component 920 can cause electronic component to displace or stretch horizontally 942. Similarly, as a person wears garment 910, the lines coupled to the electronic component 922 can cause the electronic component to displace or stretch vertically 940. The stretch information that can be gathered by electronic components (pickups) 920 and 922 can be used to determine size and shape information about a person wearing the garment 910.

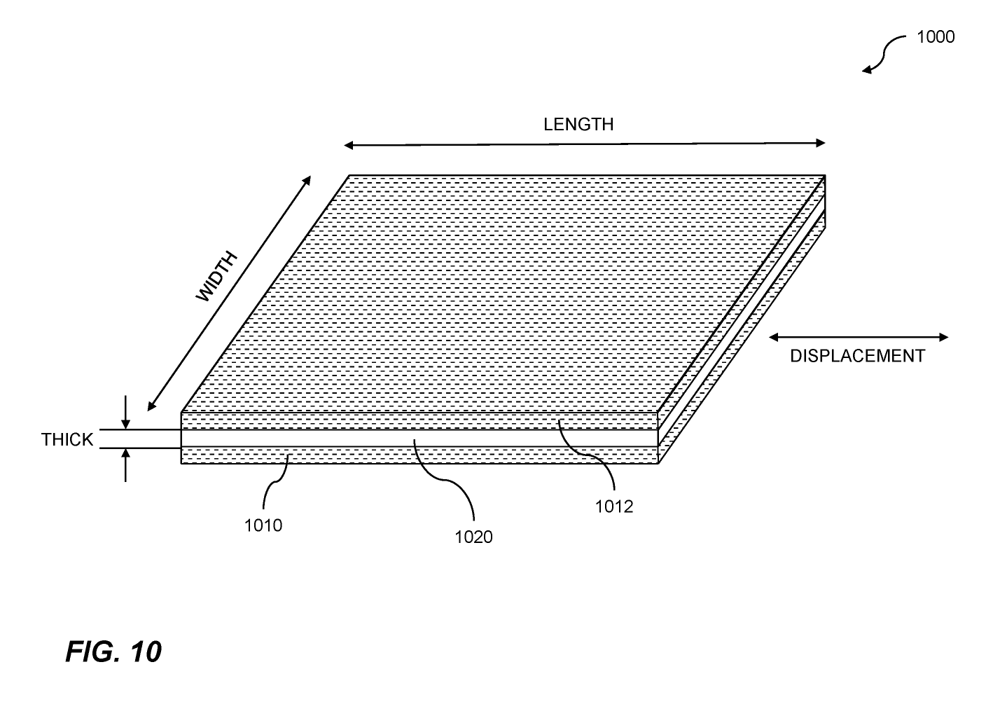

FIG. 10 illustrates electrodes and a dielectric. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. Electrodes can be separated by a dielectric to form a capacitor. In the FIG. 1000, a bottom electrode 1010 is separated from a top electrode 1012 by a dielectric 1020. The electrodes can include an electronic component that is stretchable. The electronic component can include a polymer. The stretchable electronic component can be stretchable in a single direction, denoted in the figure by displacement.

The structure of the electrodes 1010 and 1012 separated by a dielectric 1020 can be approximated by a parallel plate capacitor. The equation that describes a parallel plate capacitor is:

$$C = \frac{ɛ A}{d}$$

where C equals capacitance, epsilon-E equals permittivity, A equals length times width (area), and d equals separation, the latter denoted in 1000 by thickness. Assuming that the separation d between the electrodes remains constant as the electrode and dielectric structure is stretched, then length increases causing capacitance to also increase. By calculating the change in capacitance as a result of stretching the electronic component, shape measurement can be performed. In embodiments, as the material is stretched the dielectric can thin and/or the plate area becomes larger resulting in an increased capacitance. The increase in capacitance can be equated to an amount of stretch and thereby used for size measurement.

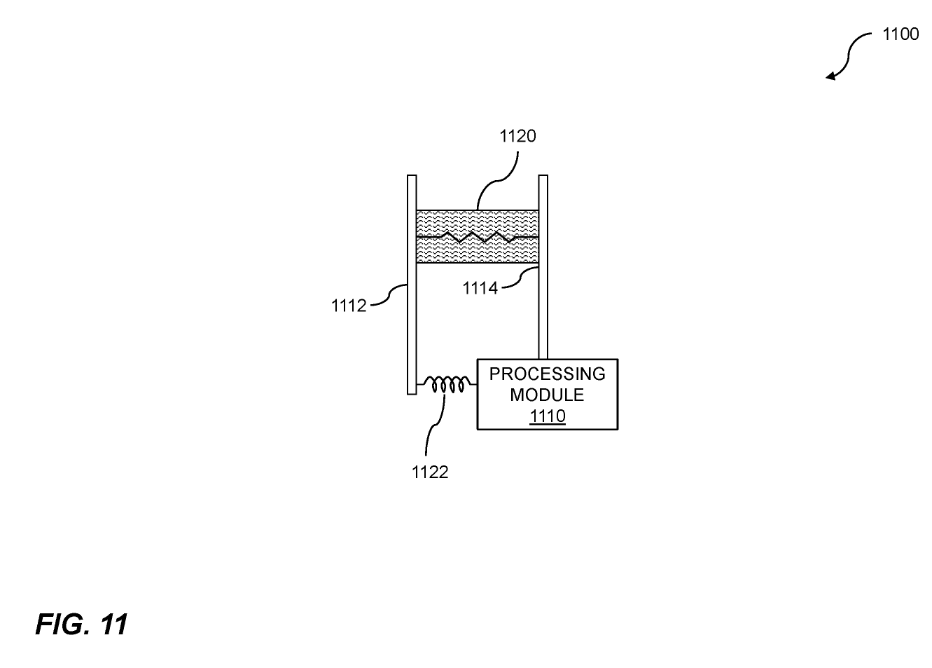

FIG. 11 shows resistive and piezoelectric sensors 1100. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include an electronic component that is stretchable. The electronic component can include a sensor that can measure an amount of stretch by the electronic component. The amount of stretch that is measured can be used for shape measurement. The stretchable electronic components 1120, 1122, and so on, can be coupled to conductive lines or threads 1112 and 1114. In embodiments, the electronic component can be a polymer. The lines 1112 and 1114 can be included in fabric, where the fabric can be woven, knitted, a Jacquard weave, and so on. The stretchable fabric can be stretchable in a single direction. The electrically conductive threads can be separated into segments. Resistance values that can result from the stretching of the stretchable electronic components 1120, 1122, etc. can be collected from the segments. A human body portion typically has a complex shape of varying size throughout. For example, a leg is typically widest at the midpoint of the quadriceps and then narrows at the knee, widens again at the calf, and comes to its narrowest point at the ankle. The use of multiple segments allows for measurement of such complex shapes. The resistive and piezoelectric sensors of 1100 that can measure resistance can further include a processing module 1110. The processing module 1110 can provide active signals to the plurality of electrically-conductive threads in order to determine the resistive values from the stretchable electronic components.

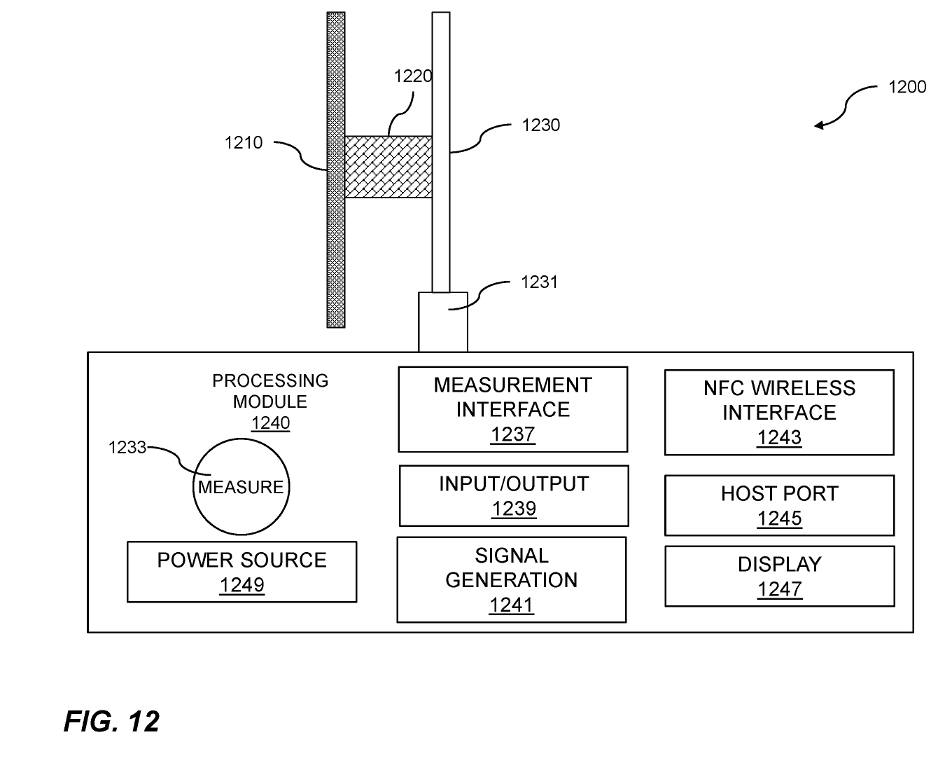

FIG. 12 illustrates a processing module for sensing. Fabric with stretchable sensors can be used for shape measurement. A measuring garment can include the fabric with stretchable sensors. The measuring garment can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. The diagram 1200 shows a garment comprising a fabric that can encompass a body portion. A sensor 1220 can be stretchable. The electronic component can include a sensor that can measure an amount of stretch by the electronic component. The electronic component can be attached to lines 1210 and 1230, where the lines 1210 and 1230 can both be stretchable, both be non-stretchable, or one be stretchable while the other is non-stretchable. The line 1230 can also contain an electrical bus that routes signals to a connector 1231. A processing module 1240 can be attachable to the connector 1231. This connector 1231 allows the processing module 1240 to be easily removed from the measuring garment, allowing for the measuring garment to be washed, cleaned, replaced, etc. The removable feature of the processing module 1240 can also facilitate the use of a single processing module to collect measurements from multiple measuring garments simply by using the connector 1231 to connect the processing module to the measuring garment.

In some embodiments, the processing module 1240 can also include a button 1233. The button 1233 can be a debounced momentary push button to signal the start of a measurement. In some embodiments, the measurement starts at a predetermined time after the measure button is pressed, in order to give the threads a chance to settle in position and reduce variability in the measurement. The processing module 1240 can further include a measurement interface 1237, including the circuitry for measuring resistance and/or capacitance. The resistance and/or capacitance values can be due to stretching of the electronic component 1220. The processing module 1240 can further include an input/output (I/O) module 1239 for receiving input signals and producing output signals. The processing module 1240 can further include a signal generation module 1241 for generating direct current (DC) and/or alternating current (AC) signals to facilitate resistance and/or capacitance measurements. The AC signals can be produced at various frequencies. The various frequencies that can be produced can be determined by the requirements of the electronic device 1220.

The processing module 1240 can also include, in some embodiments, a near field communication (NFC) wireless interface 1243. The NFC wireless interface 1243 can include a Bluetooth™ interface, Bluetooth Low Energy (BLE) interface, Zigbee™ interface, or another suitable NFC interface. The NFC wireless interface can be used to transmit raw data to a nearby computer, tablet, or another mobile device for further processing and analysis. The processing module 1240 can also include, in some embodiments, a host port 1245. The host port can include a USB port or another hardware interface such that a host computer can be directly attached to the processing module. In some embodiments, the setup of the processing module and transmission of measurement results is sent through the host port 1245. In some embodiments, power to the processing module 1240 is also be supplied through the host port 1245. The processing module 1240 can also include a display 1247. In embodiments, the display 1247 comprises a small LCD screen, e-ink display, or another suitable display. The display 1247 can be used to output sizing and/or diagnostic information, such that the information can be read directly from the measuring garment. The processing module 1240 can also include, in some embodiments, a power source 1249, which can include a rechargeable battery, a button cell battery, a lithium ion battery, a flexible battery, or another suitable power source to power the processing module 1240.

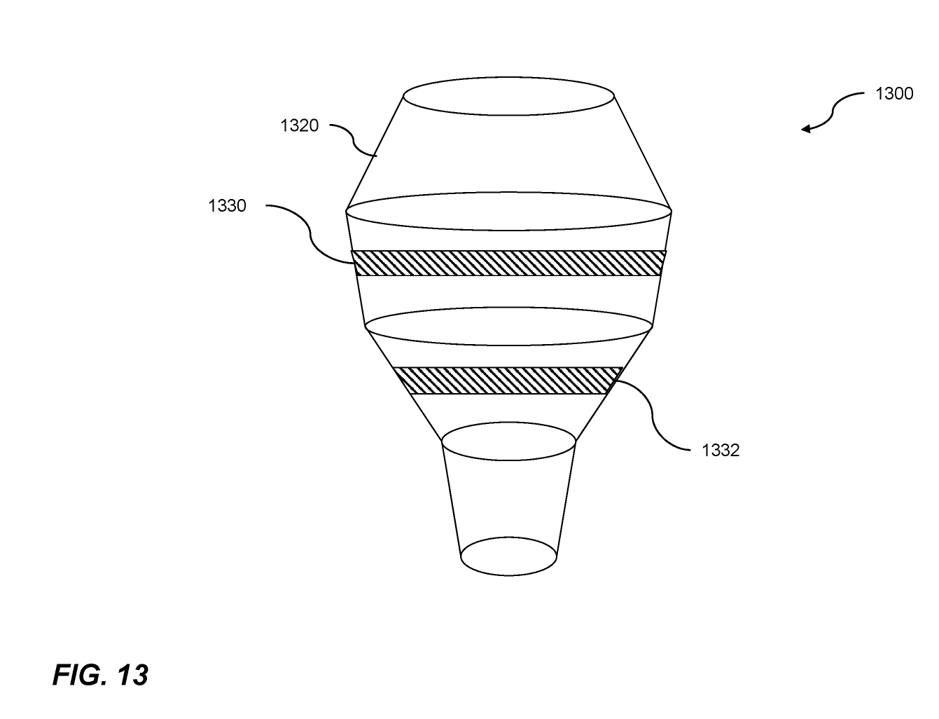

FIG. 13 is a diagrammatic representation of material for measuring a lower leg. The material for measuring can form a garment. The measuring garment can include fabric that can be formed from the material that can encompass a body portion. The measuring garment can be placed on a body portion, worn on a body portion, and so on. The garment can include a sensor module that is stretchable. The electronic component can include a sensor that can measure an amount of stretch by the electronic component. The amount of stretch that is measured can be used for shape measurement. Material that includes fabric with stretchable sensors 1300 can be used for shape measurement of human body portions including a torso, upper arms, lower arms, upper legs, lower legs, and so on. The material can include a garment 1320 that can be placed on the lower leg of a person, worn on the lower leg of a person, and so on. Similar garments can be placed on or worn on other body portions. The garment can include one or more electronic components 1330 and 1332 that can be stretchable. The electronic components 1330 and 1332 can include a sensor that can be used for measuring an amount of stretch by the one or more electronic components. By measuring an amount of stretch, the electronic components can measure a length of a body portion, a shape of a body portion, a circumference of a body portion and so on. The length that is measured can be used for sizing dimension information, where the sizing dimension information can include a length, a width, a spacing, a circumference, etc. The amount of stretch of the electronic components 1330 and 1332 can be used to measure a torso diameter, a torso length, a neck diameter, an arm diameter, an arm length, a leg diameter, a leg length, a foot diameter, a foot length, etc.

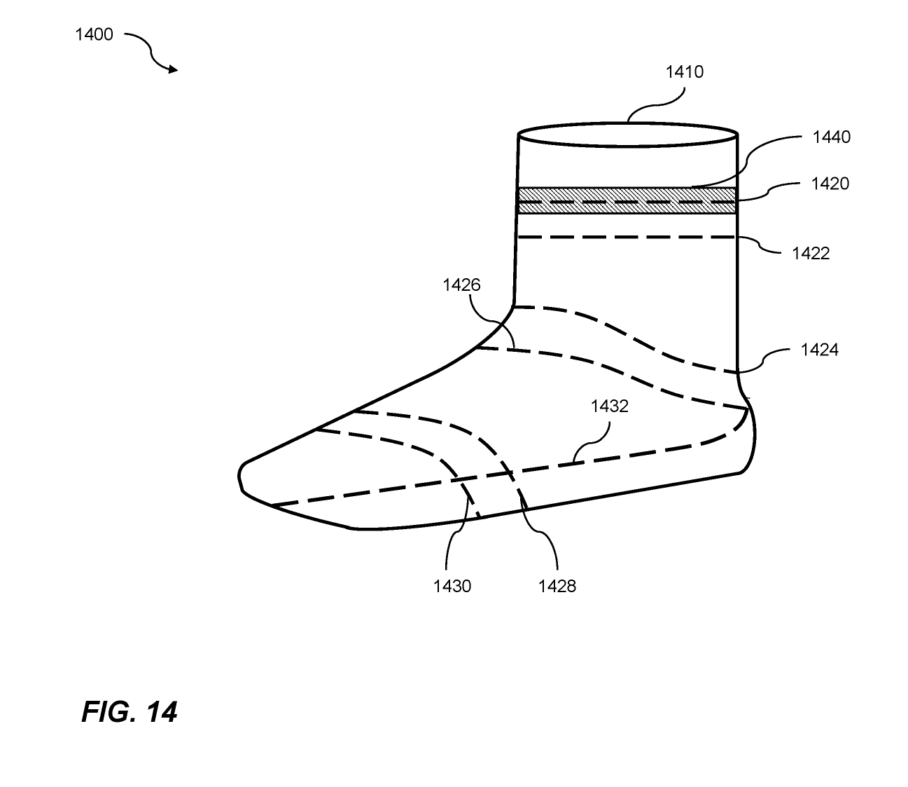

FIG. 14 illustrates a garment for detecting foot sizing. A measuring garment 1400 can include fabric that can encompass a body portion. The measuring garment can be placed on a body portion, worn on a body portion, and so on. The garment can include a sensor module that can be stretchable. The electronic component can include a sensor that can measure an amount of stretch by the electronic component. The amount of stretch that is measured can be used for shape measurement. The garment 1400 for detecting sizing can include a plurality of electronic components, where the electronic components can be stretchable. The electronic components can be electrically-conductive variable resistance threads, threads 1420, 1422, 1424, 1426, 1428, 1430, and 1432. The threads can be integrated within a fabric garment 1410. The threads can be included in a fabric where the fabric can include a textile. In other embodiments, the fabric can be woven, can be knitted, can be a Jacquard weave, and so on. In other embodiments, the threads can be electrically-conductive variable-capacitance threads. A variety of weave types can be used for the fabric garment 1410. The weave types can include, but are not limited to, plain weave, twill weave, satin weave, basket weave, leno weave, and mock leno weave. A variety of stitch types can be used for the integration of electrically-conductive variable resistance threads, including, but not limited to, miss stitches, jersey stitches, and tuck stitches. The measuring garment 1400 can be a sock adapted for measuring foot size. The electrically-conductive variable resistance thread 1432 measures a person's foot length, while the other threads measure foot or ankle width, foot circumference, foot shape, and so on. Resistance measurements from each thread can be converted to distance measurements, which can then be converted to a high level size. The high level size can be a shoe size, a sock size, and so on. While the measuring garment 1400 shows a sock for measuring foot size, many other types of measuring garments are possible. The fabric can fit to a form of an individual wherein the form can comprise a foot, an ankle, a calf, a thigh, a torso, a forearm, a hand, a finger, an upper arm, a neck, or a head.

The measuring garment 1400 can include a band 1440. The band can be a strap, a visual indicator, an alignment mark, or any other object suitable for measurement. The band can be a sensor module, where the electronic component can be stretchable. The electronic component can include one or more sensors that can measure an amount of stretch by the electronic component. The amount of stretch can be used to determine sizing dimension information such as length, width, spacing, etc. The band can be printed on the garment, coupled to the garment, woven into the garment, etc. Data collected from the band can be used to augment the data collected from the electrically-conductive threads of the garment. Any number of bands can be coupled to the garment. For the garment 1400 shown, a band 1440 can be coupled to the sock 1410.

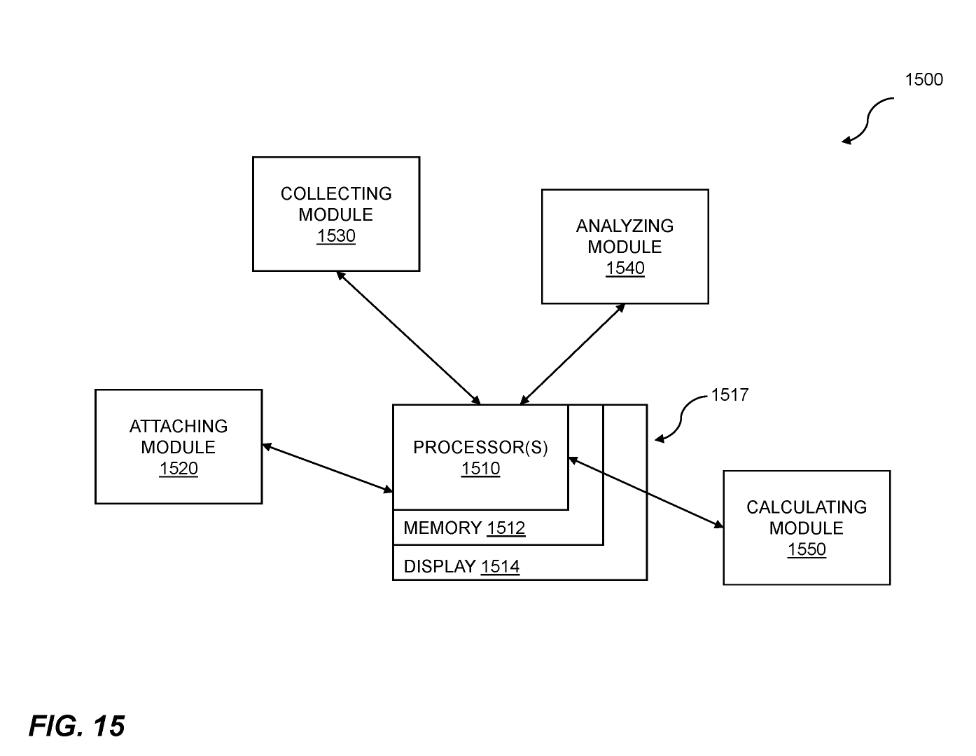

FIG. 15 describes a system for fabric with stretchable sensors for shape measurement. A fabric garment with stretchable sensor modules can be used for shape measurement. A measuring garment can include the fabric with stretchable sensor modules. The measuring garment can encompass a body portion. The measuring garment can be placed on a body portion, worn on a body portion, and so on. The garment can include a sensor module that is stretchable. The sensor module can provide electrical data based on an amount that the sensor module is stretched. The electrical data can be collected and analyzed, and a size for the body portion can be calculated based on the collecting and the analyzing. The amount of stretch that is measured can be used for shape measurement. The system 1500 can include an attaching module 1520, a collecting module 1530, an analyzing module 1540, a calculating module 1550, and an analysis computer 1517. The analysis computer 1517 can comprise one or more processors 1510, a memory 1512 coupled to the one or more processors 1510, and a display 1514 configured and disposed to present user interface information. The analyzing module 1540 can include a database and/or lookup table including empirically derived values, and can also include calibration data. The calculating module 1550 can comprise one or more processors, a battery coupled to the one or more processors, a communication device, and so on. The analyzing module 1540 can include resistance and/or capacitance measuring hardware and can include hardware for measuring current, voltage, resistance, capacitance, and/or inductance. The collecting module 1530 can include hardware for generating direct current and/or alternating current signals used for obtaining resistance and/or capacitance measurements. Typically, the current values are low (e.g. microamperes) and in embodiments, the frequency range includes signals from about 100 hertz to about 1 megahertz.

The system 1500 can comprise a system for body measurement comprising: a memory which stores instructions; one or more processors coupled to the memory wherein the one or more processors, when executing the instructions which are stored, are configured to: attaching a sensor module to a garment, wherein the sensor module is stretchable and provides electrical data based on an amount that the sensor module is stretched, and wherein the garment encompasses a body portion; collecting the electrical data from the sensor module based on the amount that the sensor module stretched; analyzing the electrical data that was collected to determine a measurement for the amount that the sensor module stretched; and calculating a size for the body portion based on the measurement that was determined. In embodiments, the system 1500 can include computer program product embodied in a non-transitory computer readable medium for body measurement, the computer program product comprising code which causes one or more processors to perform operations of: attaching a sensor module to a garment, wherein the sensor module is stretchable and provides electrical data based on an amount that the sensor module is stretched, and wherein the garment encompasses a body portion; collecting the electrical data from the sensor module based on the amount that the sensor module stretched; analyzing the electrical data that was collected to determine a measurement for the amount that the sensor module stretched; and calculating a size for the body portion based on the measurement that was determined.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate, execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A processor-implemented method for body measurement comprising:
attaching a sensor module to a garment, wherein the sensor module is stretchable and provides electrical data based on an amount that the sensor module is stretched, and wherein the garment encompasses a body portion;
collecting the electrical data from the sensor module based on the amount that the sensor module stretched;
analyzing the electrical data that was collected to determine a measurement for the amount that the sensor module stretched; and
calculating a size for the body portion based on the measurement that was determined.

2. The method of claim 1 wherein the analyzing produces electrical information.

3. The method of claim 2 wherein the analyzing is performed on the sensor module.

4. The method of claim 3 further comprising transmitting the electrical information to a computing device.

5. The method of claim 4 wherein the transmitting is accomplished over a wireless network.

6. (canceled)

7. The method of claim 1 wherein the garment comprises non-stretchable fabric.

8. The method of claim 7 wherein the garment is lacking non-stretchable fabric where the sensor module resides.

9. The method of claim 7 wherein the garment has no fabric where the sensor module resides.

10. The method of claim 7 wherein the garment further comprises stretchable fabric where the sensor module resides.

11-12. (cancelled)

13. The method of claim 1 wherein all of the garment encompassing the body portion is stretchable.

14. The method of claim 13 wherein the sensor module is integrated within the garment encompassing the body portion.

15. The method of claim 1 further comprising:
attaching a second sensor module to the garment;
collecting a second electrical data from the second sensor module, wherein the second electrical data is collected based on stretching of the second sensor module;
analyzing the second electrical data that was collected to determine a second measurement for the amount that the second sensor module stretched; and
further calculating the size for the body portion based on the measurement and the second measurement that were determined.

16. The method of claim 15 further comprising transmitting the electrical data and the second electrical data to a computing device, wherein the transmitting is performed by distinct wireless transmitters.

17-18. (canceled)

19. The method of claim 1 wherein the sensor module is integrated with a closing device.

20. (canceled)

21. The method of claim 1 wherein the sensor module measures a circumference of the body portion.

22. The method of claim 1 wherein the sensor module measures a length of the body portion.

23. The method of claim 1 wherein the sensor module comprises a stretchable capacitive material.

24. (canceled)

25. The method of claim 1 wherein the sensor module comprises a stretchable resistive material.

26. (canceled)

27. The method of claim 1 wherein the sensor module comprises a polymer.

28. The method of claim 1 wherein the sensor module comprises:
at least one sensor;
one or more electrical devices communicatively coupled to the at least one sensor;
a battery coupled to the one or more electrical devices; and
a communication device.

29-39. (cancelled)

40. The method of claim 1 further comprising a coupling zipper attached to the garment encompassing the body portion.

41. The method of claim 40 wherein the coupling zipper actuates the sensor module to collect the electrical data as the coupling zipper secures the garment encompassing the body portion.

42. The method of claim 1 further comprising a coupling button attached to the garment encompassing the body portion.

43. The method of claim 42 wherein the coupling button actuates the sensor module to collect the electrical data as the coupling button secures the garment encompassing the body portion.

44. (canceled)

45. The method of claim 1 further comprising a finger loop attached to the garment encompassing the body portion.

46. The method of claim 45 wherein a tug on the finger loop actuates the sensor module to collect the electrical data on the garment encompassing the body portion.

47. (canceled)

48. A computer program product embodied in a non-transitory computer readable medium for body measurement, the computer program product comprising code which causes one or more processors to perform operations of:
attaching a sensor module to a garment, wherein the sensor module is stretchable and provides electrical data based on an amount that the sensor module is stretched, and wherein the garment encompasses a body portion;
collecting the electrical data from the sensor module based on the amount that the sensor module stretched;
analyzing the electrical data that was collected to determine a measurement for the amount that the sensor module stretched; and
calculating a size for the body portion based on the measurement that was determined.

49. A system for body measurement comprising:
a memory which stores instructions;
one or more processors coupled to the memory wherein the one or more processors, when executing the instructions which are stored, are configured to:
attaching a sensor module to a garment, wherein the sensor module is stretchable and provides electrical data based on an amount that the sensor module is stretched, and wherein the garment encompasses a body portion;
collecting the electrical data from the sensor module based on the amount that the sensor module stretched;
analyzing the electrical data that was collected to determine a measurement for the amount that the sensor module stretched; and
calculating a size for the body portion based on the measurement that was determined.
